(19) United States
(12) Patent Application Publication
(10) Pub. No.: US 2016/0253366 A1
(43) Pub. Date: Sep. 1, 2016

(54) ANALYZING A PARALLEL DATA STREAM USING A SLIDING FREQUENT PATTERN TREE

(71) Applicant: HEWLETT PACKARD ENTERPRISE DEVELOPMENT LP, Houston, TX (US)

(72) Inventors: Meichun Hsu, Los Altos Hills, CA (US); Qiming Chen, Cupertino, CA (US)

(21) Appl. No.: 15/028,785

(22) PCT Filed: Oct. 15, 2013
(86) PCT No.: PCT/US2013/064934

§ 371 Date: Apr. 12, 2016

(51) Int. Cl. G06F 17/30; G06F 9/48

(52) U.S. Cl. CPC G06F 17/30327; G06F 17/30516; G06F 9/4881

(57) ABSTRACT

A technique for analyzing a parallel data stream using a sliding FP tree can include create a sliding FP tree using input tuples belonging to a parallel sliding window boundary and analyze patterns of the parallel data stream in the parallel sliding window boundary.

### BACKGROUND

Data can be sent and/or received as a data stream. A data stream can include a continuous stream of data that can be sent tuple by tuple. A data stream of tuples can be processed in a particular order.

### BRIEF DESCRIPTION OF THE DRAWINGS

FIG. 1 is a diagram illustrating an example of an environment for analyzing a parallel data stream according to the present disclosure.

FIG. 2 is a diagram illustrating an example of, a process for creating a sliding frequent pattern (FP) tree according to the present disclosure.

FIGS. 3A-3B illustrate examples of systems according to the present disclosure.

FIG. 4 is a flow chart illustrating a process for analyzing a parallel data stream using a sliding FP tree according to the present disclosure.

FIG. 5 is a flow chart illustrating an example of a method for analyzing a parallel data stream using a sliding FP tree according to the present disclosure.

### DETAILED DESCRIPTION

Due to the popularity of applications that process multiple pieces of data in real-time or near-real-time, use of streaming systems has increased. An example streaming system, can include a distributed streaming system which can perform parallel processing (e.g., perform processing of portions of a data stream simultaneously). Such data streams can be referred to as parallel data streams. The parallel data stream can include a sequence of data events (e.g., tuples).

The sequence and/or order of communicating the data stream from a particular source to a particular destination (e.g., the dataflow) can be represented as a graph structure having nodes and edges. A node can include an electronic device and/or computer readable instructions that are capable of sending, receiving and/or forwarding a data stream over a streaming system. In some examples, an electronic device can include a plurality of nodes. The tuples can be sent in a particular order from one node to another. Each node can include a task (e.g., an instance) that receives and sends tuples.

A streaming system can include a number of interconnected operations. An operation can include computer readable instructions that perform a particular function. For example, an operation can include computer readable instructions to “move object x” and/or “calculate the distance between objects x and y”. The execution of an operation can be divided into a number of intervals (e.g., states) based on the messages that the operation receives. These states can include a deterministic sequence of sub-operations, started by the receipt of a particular message by the operation. As used herein, a message can include a number of bits of data.

In some examples, each of the interconnected operations can include as number of parallel instances (e.g., tasks). That is, an operation can include multiple tasks running in parallel to perform a function. A task can receive input messages from an upstream task (e.g., a task upstream of the receiving task), derive new messages, and send the new messages to a downstream task (e.g., a number of tasks downstream of the receiving task). The number of tasks of each operation can vary based on computing demand (e.g., an elastic dataflow).

In a streaming system, parallel and distributed tasks can be executed one after the other (e.g., chained transactional tasks). In other words, chained transactional tasks can include a linear succession of tasks that are to be executed sequentially. In a parallel data stream, a task may have a plurality of upstream tasks, herein referred to as “input channels”.

It can be desirable to find frequent patterns (e.g., patterns that occur frequently) in a data stream for a variety of applications. For instance, frequent patterns can be beneficial for applications such as retail market data analysis, network monitoring, web usage mining, and stock market prediction. Data mining methods can be applied to a data stream to derive information about patterns expressed in the data stream. Unlike static data, mining frequent patterns from a parallel data stream, in general, has additional processing considerations. For instance, items in a data stream can be examined once and processed as fast as possible with limited available memory.

To derive patterns in a data stream, a sliding window model can be used. A sliding window model can include processing recently-generated data from a fixed length of time (e.g., in a window). The window can be divided into several slides (e.g., panes or batches). A slide can include a sub-portion of time, wherein a slide is a smaller amount of time than the window. Frequent patterns can be analyzed in each slide individually. Once a first window boundary is reached, the frequent patterns can be combined from the slides. The frequent patterns can be analyzed by creating a FP tree, for instance.

An FP tree, as used herein, can include a data structure that represents a data set in a tree form and can be created using an FP-Growth function (e.g. an algorithm). An FP tree can be created by passing over a data set twice, and frequent item-sets can be identified by traversal through the FP tree. However, using the sliding window model to create an FP tree does not consider that in a parallel data stream, input tuples from different input channels in the parallel processing may not be synchronized. That is, tuples can be received out of order. Further, processing the multiple input channels can result in a large FP tree that can use significant memory.

In contrast, in accordance with a number of examples of the present disclosure, a plurality of sliding FP trees can be created across parallel sliding windows. The sliding FP trees can be created, for instance, by an operation composed of a plurality of task instances (e.g., the sliding FP tree operation can be parallelized). Each of the plurality of task instances, as used herein, can include an instance of the task running on a distributed computing node. Each sliding FP tree can be created for a task instance (e.g., a single sliding FP tree for each task instance) that can be incrementally created across a parallel sliding window (e.g., the sliding FP tree is incrementally created). A window based summary (e.g., combination of frequent patterns identified in each sliding FP tree at the conclusion of the window) can be determined once input channels for the operation have reached a boundary of the current parallel sliding window. An input tuple belonging to a future parallel sliding window that is received prior to all input channels reaching the boundary of the current parallel sliding window can be held until the boundary is reached. Once all input channels (e.g., for a task instance) reach the boundary, obsolete data can be removed from the sliding FP tree (e.g., data from a slide belonging to both the current parallel sliding window and a previous sliding window), a window based summary can be input into a pattern count map, and input tuples from the next parallel sliding window can be processed.

Using parallel sliding windows can allow for analyzing a parallel data stream for frequent patterns. The plurality of sliding FP trees that individually slide can reduce the amount of memory to store the results as compared to an individual FP tree. Furthermore, holding input tuples until a future parallel sliding window can allow for synchronization of analysis of the multiple input channels for a task instance. The plurality of sliding FP trees, as used herein, can include partial sliding FP trees for the data set of the parallel data stream (e.g., for a single parallel sliding window).

As used herein, a sliding FP tree can include a data structure that represents a data set in a tree form and that is created incrementally across a plurality of parallel sliding windows. The parallel sliding windows can have overlapping slides, thereby allowing item-sets stored on the tree to be reused across the overlapping window boundaries (e.g., slides).

An FP tree is traditionally created by two-passes over the data set. The data set is passed to determine a frequent count of each item, discard infrequent items (e.g., items below a threshold frequency), and sort the frequent items in decreasing order. The data set is then passed one transaction at a time to create the FP tree. For each transaction, if the transaction is unique a new path is formed on the tree and a counter for each node is set to 1. If the transaction shares a common item and/or item-set, then the counter for common item and/or the item-set node(s) is increased, and new nodes are created. This process is continued until all transactions are added to the tree. A transaction, as used herein, can include a tuple and a pattern (e.g., a tuple with an ordered item-set, such as a to b to c). However, creating a sliding FP tree, in accordance with examples of the present disclosure, can include creating a sliding FP tree using a single pass over the data set.

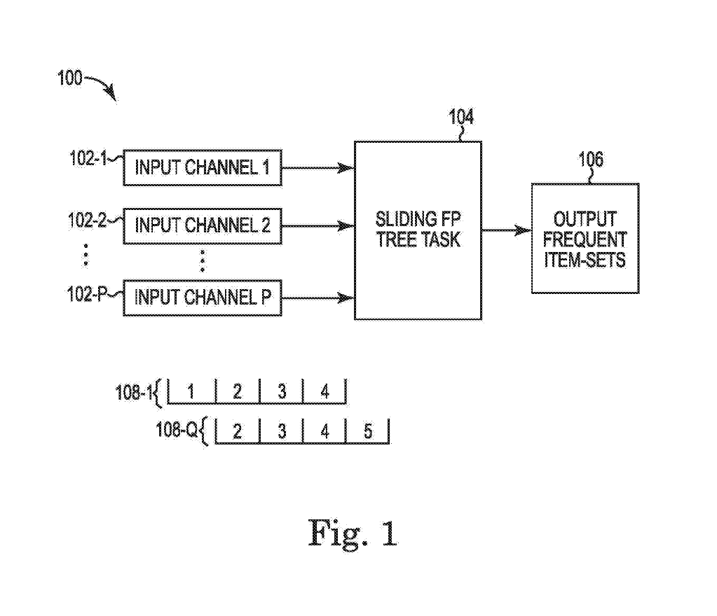

FIG. 1 is a diagram illustrating an example of an environment 100 for analyzing a parallel data stream according to the present disclosure. The environment 100 can include, for instance, a sub-portion of a streaming system.

A streaming system, as used herein, can include a number of interconnected operations. Each of the number of interconnected operations can include a number of tasks. In some examples, tasks can include computer readable instructions that execute on a processor to perform a particular function, such as a particular arithmetic function. The streaming system can include an upstream task (e.g., an upstream node) sending data (e.g., a tuple) over an input channel (e.g., input channels 102-1, 102-2, . . . , 102-P) to a downstream task (e.g., a downstream node). The input channel can be used to send tuples from the data stream in sequential order.

The environment 100 can include a plurality of upstream tasks (e.g., an upstream node) sending data (e.g., a tuple) over a plurality of input channels 102-1, 102-2, . . . , 102-P (herein generally referred to as “input channels 102”) to a downstream task (e.g., a downstream node). The downstream task, as illustrated in FIG. 1, can include a sliding FP tree task 104. An input channel, as used herein, can include a communication link between an upstream node and a downstream node. The upstream tasks can send a message over the input channels 102 to the sliding FP tree task 104. The sliding FP tree task 104 can, for instance, output frequent item-sets 106. In various instances, the sliding FP tree task 104 can send the output frequent item-sets 106 to a downstream node (e.g., not illustrated in the example of FIG. 1).

Although the present example of FIG. 1 illustrates a single task (e.g., sliding FP tree task 104) and three input channels 102, examples in accordance with the present disclosure are not so limited. The environment 100 can include a plurality of tasks, and each task can have one or a plurality of input channels. That is, the environment 100 can include a sub-set of a total streaming system. Further, the sliding FP tree task 104, in various examples, can include a plurality of task instances (e.g., as discussed further herein).

In some examples, the sliding FP tree task 104 can analyze input tuples from the plurality of input channels 102 over a number of parallel sliding windows 108-1, . . . , 108-Q. A parallel sliding window, as used herein, can include a set of all transactions (e.g., tuples with a pattern) between a parallel sliding window boundary. The parallel sliding window boundary can be based on a window size. The window size can include a pre-defined number of granules per window. For instance, a window size can include a number of granules per parallel sliding window. A parallel sliding window boundary can be reached, for instance, when the parallel sliding window reaches a set window size (e.g., a granule that makes the window size equal to a set number of granules per parallel sliding window).

A granule, as used herein, can include a basic unit. An example granule can include minutes, wherein the granule numbers of a plurality of input tuples can form a sequence of minutes. For instance, each input tuple can carry information of its granule. A first parallel sliding window boundary, if starting at granule 1, can be granule 1 to granule z wherein granule z is the set window size. For instance, if the set window size is 60 granules and granule is one minute, parallel sliding window 1 can be minute 1 to minute 60.

The parallel sliding windows 108-1, . . . , 108-Q can be divided into sub-windows, called slides (e.g., 1, 2, 3, 4 as illustrated in the first parallel sliding window 108-1 and 2, 3, 4, 5 as illustrated in the second parallel sliding window 108-Q). The slides of the parallel sliding windows can overlap (e.g., slide 2, 3, and 4 belong to both the first parallel sliding window 108-1 and the second parallel sliding window 108-Q). The size of the slide can be pre-defined to a number of granules per slide. For example, if the window size is 60 granules, the slide size can include a value less than 60 (e.g., 15 granules). In such an example, each parallel sliding window can have 4 slides (e.g., 60 granules divided by 15 granules equals 4).

A sliding FP tree task 104 can analyze input tuples based on the slides. For instance, a sliding FP tree can be created for the input channels 102 by processing input tuples in a slide-by-slide process (e.g., process tuples belonging to slide 1 of the first parallel sliding window 108-1, followed by slide 2, followed by slide 3, and followed by slide 4) followed by combining (e.g., aggregating) the results of each slide (e.g., window summary of patterns identified) to form a window summary.

In a parallel data stream, input tuples from differing input channels may not be received in the correct order. For instance, the sliding FP tree task 104, in some examples, can include a plurality of sliding FP tree task instances (e.g., parallelize task instances of the sliding FP tree task operation). Each of the plurality of sliding FP tree task instances may have a plurality of input channels (e.g., similar to the input channels 102 for the sliding FP tree task 104). In order to parallelize the plurality of sliding FP tree task instances, input tuples that are received out of order can be held. For instance, an input tuple can be held from the first parallel sliding window 108-1 based on the input tuple belonging to the second parallel sliding window 108-Q (e.g., as discussed further herein). In such examples, a window summary can be across the plurality of sliding FP trees (e.g. the results and/or outputs of the sliding FP trees are combined).

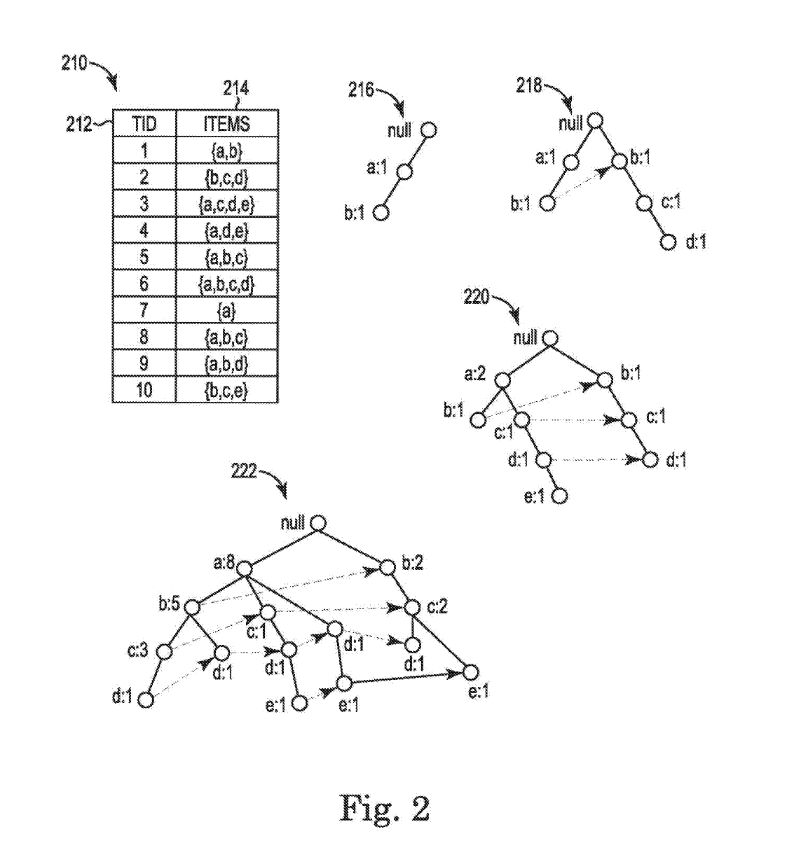

FIG. 2 is a diagram illustrating an example of a process for creating a sliding FP tree 222 according to the present disclosure. The sliding FP tree 222 created can include a sliding FP tree for input channels of a single sliding FP tree task instance over a single parallel sliding window (e.g., first sliding window 108-1 as illustrated in FIG. 1).

As illustrated by FIG. 2, input data 210 can be scanned to create a sliding FP tree 222. The input data 210 can include a transaction data set. The transaction data set can include transactions within the first parallel sliding window boundary. That is, a parallel sliding tree for a sliding FP tree task instance can be created using input tuples (e.g., from identified input channels) belonging to a first parallel sliding window boundary. Input tuples belonging to a parallel sliding window boundary, as used herein, can include transactions occurring within the boundary of the parallel sliding window. A first parallel sliding window, as used herein, can include a current parallel sliding window (e.g., a parallel sliding window currently being analyzed). The boundary of the first parallel sliding window can include a range of granules. Transactions occurring within the range of granules of the parallel sliding window can be referred to as “occurring within the parallel sliding window”. A transaction occurring within the range of granule can include a transaction with a granule number that is within the range, for instance.

Transactions, as used herein, can include a tuple (e.g., tid 212) with a particular pattern D. Tid, as used herein, can include a transaction identifier (ID) and can include a pattern. A pattern, as used herein, can include an item-set 214 (e.g., an order and/or path of items). For instance, an item-set can include {a,b}, {b,c,d}, {a,c,d,e}, among other item-sets. Each transaction contains a transaction identifier (tid), a field where a granule number (e.g., minute) can be extracted, and an item-set (a, b).

Each input transaction (e.g., tuple) is grouped into three groupings: granule, slide, and parallel sliding window. A granule, as discussed above, can include a basic unit, such as a minute. The granule number of each input transaction can be extracted. The slide is defined based on an upper granule number of the slide (e.g., a ceiling is defined based on a pre-defined number of granules per slide). The parallel sliding window is a number of granules per window (e.g., window size is greater or equal to a slide size). In data stream processing, after a first parallel window boundary is reached, the ceiling of a slide and the ceiling of the first parallel window boundary are coincident (e.g., the same).

The sliding FP tree (e.g., sliding FP tree 222) can be organized based on an initial sequence of pre-ordered items. For instance, the order can be based on a frequency of the items. The pre-ordering can be estimated based on past experience or a training data set (e.g., historical data). For example, if a data set includes items a through z, an example sequence can include:

Itemsequence=“a,b,c,d,e,f,g,h,i,j,k,l,m,n,o,p,q,r,s,t,u,v,w,x,y,z”.

The initial sequence of pre-ordered items can be used to compress the input data 210 into a tree structure (e.g., sliding FP tree 222). The sliding FP tree 222 can be created by reading transactions (e.g., tid 212) one by one, creating paths (e.g., item-sets 214), and putting the paths on the tree. The nodes (e.g., the circles illustrated in each partial sliding FP tree 216, 218, and 220 and the sliding FP tree 222) correspond to items (e.g., a, b, c, d, e) and have a counter. The counter can include a numerical value representing a frequency of the item (e.g., a count).

The FP growth function reads one transaction (e.g., transaction 1 of a,b) at a time and maps the transaction to a path. The initial sequence of pre-ordered items is used, so paths can overlap when transactions share items (e.g., when they have the same prefix). The counters are incremented across common paths. Further, pointers (e.g., arrows with dashed lines) can be maintained between nodes containing the same items (e.g., b:1 to b:1 illustrated in the partial sliding FP tree 218). A partial sliding FP tree, as used herein, can include a sliding FP tree with created paths of a sub-set of ail transactions in the slide, parallel sliding window, task instance, and/or data set analyzed, among other sub-sets of transactions.

Paths with different prefix items (e.g., leading items) are disjoint as they do not share a common prefix. A prefix item, as used herein, can include a leading item of a path (e.g., an item that starts a path). Paths sharing a common prefix item can overlap and the frequency count for the node with the overlap can be increased by one.

For example, a first partial sliding FP tree 216 can be created by reading transaction 1 containing item-set {a,b}. Two nodes representing a and b can be created and the path null to node a to node b. Null, as used herein, can include a root node (e.g., a node on the tree data tree structure with no parent node, the starting node). The counters of a and b are set to 1.

A second partial sliding FP tree 218 can be created by reading transaction 2 containing item-set {b,c,d}. Three nodes representing b, c, and d can be created, and the path null to node b to node c to node d can be added to the first partial sliding FP tree 218 to create the second partial sliding FP tree 218. The counters for b, c, and, d are set to one. Note that although transaction 1 and transaction 2 share node b, the paths are disjoint as they do not share a common prefix. Further, a pointer is added to connect the two b nodes.

A third partial sliding FP tree 220 can be created by reading transaction 3 containing item-set {a,c,d,e}. Three nodes representing c, d, and e can be created and the path null to node a to node c to node d to node e can be added to the second partial sliding FP tree 218 to create the third partial sliding FP tree 220. Note that transaction 3 shares a common prefix item (e.g., item a) with transaction 1 so the path of transaction 1 and transaction 3 overlap and the counter for a is increased by one (e.g., so it is now 2). The counters of c, d, and e added in the third partial sliding FP tree 220 are set to one. Further, pointers are added to connect the two c nodes and two d nodes.

This process can be repeated until all transactions (e.g., the ten transactions) are read and added to create the sliding FP tree 222. The sliding FP tree 222 is thereby incrementally created and usually is a smaller size than the uncompressed data (e.g., input data 210). This is because typically many transactions share items and/or prefixes. The size of the sliding FP tree 222 can depend on how the items are ordered.

Using the sliding FP tree 222, frequent item-sets can be extracted. For instance, the extraction can occur starting at the bottom nodes (e.g., node e) to the root (e.g., node null). That is, frequent item-set ending in a are identified, then de etc. . . . d then cd, etc. In general, it first extracts prefix path sub-trees (e.g., a sup-tree containing the tern and/or item-set) ending in an item and/or item-set using the linked list. Each prefix path sub-tree is processed recursively to extract frequent item-sets. Solutions are then merged (e.g., the prefix path sub-tree for e will be used to extract frequent item-sets end in e, then in de, cc, be, and ae, then is cde, bde, cde, etc.)

In various examples, the process an disregard item-sets with a frequency below a threshold frequency. A threshold frequency can include a count value (e.g., 10, 50, 100). For instance, if a threshold frequency is 10, an item-set with a frequency of 2 can be disregarded (e.g., not included in the summary and/or not counted). The threshold frequency can be predefined, for instance.

As previously discussed, the sliding FP tree 222 can include a sliding FP tree for input channels of a sliding FP tree task instance (e.g., wherein a sliding FP tree operation is parallelized to include a plurality of sliding FP task instances) in a first parallel sliding window boundary (e.g., a current parallel sliding window). Upon reaching a second parallel window boundary (e.g., the next parallel sliding window), the results of the window are summarized from the tree and put into a pattern count map. A pattern count map can include an index data structure (e.g., a hash map) to store pattern frequency pairs for each parallel sliding window.

In a parallel data stream, the patterns of each of the plurality of sliding FP trees (e.g., for each of the plurality of sliding FP task instances) can be combined in response to an input tuple from each input channel reaching a boundary (e.g., granule boundary) of the first parallel sliding window. That is, the sliding FP tree 222 for a sliding FP task instance in a first parallel sliding window can be combined with sliding FP trees for each sliding FP task instance in the first parallel sliding window (e.g., the current sliding parallel window). The results of the sliding FP tree for each sliding FP task instance can be combined, in various instances, to summarize the results of the window.

A boundary, as used herein, can include a granule ceiling of a parallel sliding window. That is, pattern count maps of each sliding FP task instance are combined to summarize the results for a window. The parallel siding windows are punctuated, for instance, by determining if each input tuple belongs to the first parallel sliding window (e.g., a current parallel sliding window) or a second parallel sliding window (e.g., a future parallel sliding window). An input tuple that is received that belongs to a second parallel window boundary is held (e.g., temporarily stored for future processing), and an input tuple belonging to the first parallel window boundary is processed. Determining when to summarize a parallel sliding window and/or process the next parallel sliding window can be dependent on a current granule number (e.g., of processing). For example, upon receiving an input tuple, a boundary of the first parallel sliding window (e.g., the current parallel sliding window) and/or slide is checked based on the current granule number.

The current granule number, as used herein, includes the minimum (eq., lowest) granule number of all input channels. This information is used to determine whether to process or hold the input tuple. A granule number of each input channel can include the largest granule of an input tuple received from the input channel. For example, channel 1 can have a granule number of 10 and channel 2 can have a granule number of 9. The current granule number, in such an example, includes 9 (e.g., the minimum granule number of channel 1 and channel 2 is 9). Once the granule number for each of input channels reaches a boundary of the first parallel sliding window, the second (e.g., next) parallel sliding window can be processed.

In some examples, determining when to summarize a parallel sliding window and/or process the second (e.g., next) parallel sliding window can occur independently at each sliding FP task instance. In such an example, a window summary across the plurality of sliding FP task instances can occur based on the parallel sliding window boundary (e.g., once each sliding FP tree task instance reaches the boundary, the results and/or outputs can be combined).

In various instances, the granule number of each input channel and/or the current granule number can be updated. For instance, a granule number of an input channel can be updated in response to an input tuple received with a granule number that is greater than the present value of the granule number (e.g., if the granule number of input channel is 9 and an input tuple with a granule number of 10 is received, the granule number of input channel is updated to 10). A current granule number can be updated as a minimum granule number of all input tuples from each input channel in response to an update of a granule number of an input channel. For instance, if the minimum granule number of alp input channels is 9, and the input channel with the lowest granule number (e.g., of 9) receives an input tuple with a granule number of 10, the current granule number can be updated to 10.

When processing the new parallel sliding window (e.g., the second parallel sliding window), patterns of tuples that belong to a slide that is within both the first (e.g., current) parallel sliding window and a previous sliding parallel window are subtracted from the tree nodes and, in order to do so, the input tuples are pooled with the sliding as well. The subtracted patterns can include patterns identified from an earliest slide (e.g., a slide with a lowest granule ceiling) of the first parallel sliding window. Further, held input tuples that belong to the new parallel sliding window (e.g., now the current parallel sliding window) are processed, and held input tuples that belong to a future parallel sliding window can continue to be held.

The following includes an example of analyzing a parallel data stream using a sliding FP tree. Input transactions are grouped into granules, slides, and windows. The sliding FP tree is organized based on an initial sequence of pre-order items (e.g., pre-ordered by frequency). The frequent item-sets are, analyzed using four operations in the following order: spout, sort, fp, and combine. Spout operation generates stream tuples with fields “granule”, “tid”, and “item-set”, where a transaction is represented as an item-set and tid stands for the transaction ID. Sort operation sorts transactions based on pre-ordered item sequence, where the output fields include “granule”, “tid”, “prefix”, and “itemlist”. FP operation slides the FP-tree, where the output is item-sets and counts in each parallel sliding window and includes fields “window”, “item-set”, and “counter”. Combine operation combines the output of multiple fp task with the output fields “window”, “item-set” and “counter”.

These operations can be parallelized. That is, each operation can have multiple task instances running on distributed computing nodes. To process the data, the data sent from the task of an upstream operation to the task of a downstream operation are partitioned in the following way. The spout operation output goes to the sort tasks with fields “granule, lid”, and “item-set”, which are shuffle partitioned (e.g., random with load balance). The sort operation output goes to fp tasks with fields “granule”, “tid”, “prefix”, and “itemlist” that are field-partitioned by “prefix”. The fp operation output goes to combine tasks with fields “window”, “item-set”, and “counters”, which are field-partitioned by item-set. Combine operation output goes to the task of one or more potential operations for further analysis with fields “window”, “item-set”, and “counter”, which may be field-partitioned by item-set.

As an example, a reference of the dataflow topology can be specified as:

TopologyBuilder builder=new TopologyBuilder( );

builder.setSpout(“spout”,
new FilechunkItemsetSpout(filename, chunk_size))’

builder.setBolt(“sort”,
new FPItemsetSortBolt(Itemsequence), N)
.shuffleGrouping (“spout”);

builder.setBolt(“slidefp”,
new FPSlidingWindowBolt (window_size, slide_size, chunk_size, Itemsequence), N̅)
.fieldsGrouping (“sort”, new Fields (“prefix”));

builder.setBolt (“combine”,
new FPWindowCombineBolt(1, threshold), 1)
.fieldsGroupings (“slidefp”, new Fields (“itemset”));

builder.setBolt(“print”, new FPPrintBolt ( ), 1)
.fieldsGrouping (“combine”, new Fields (“itemset”));

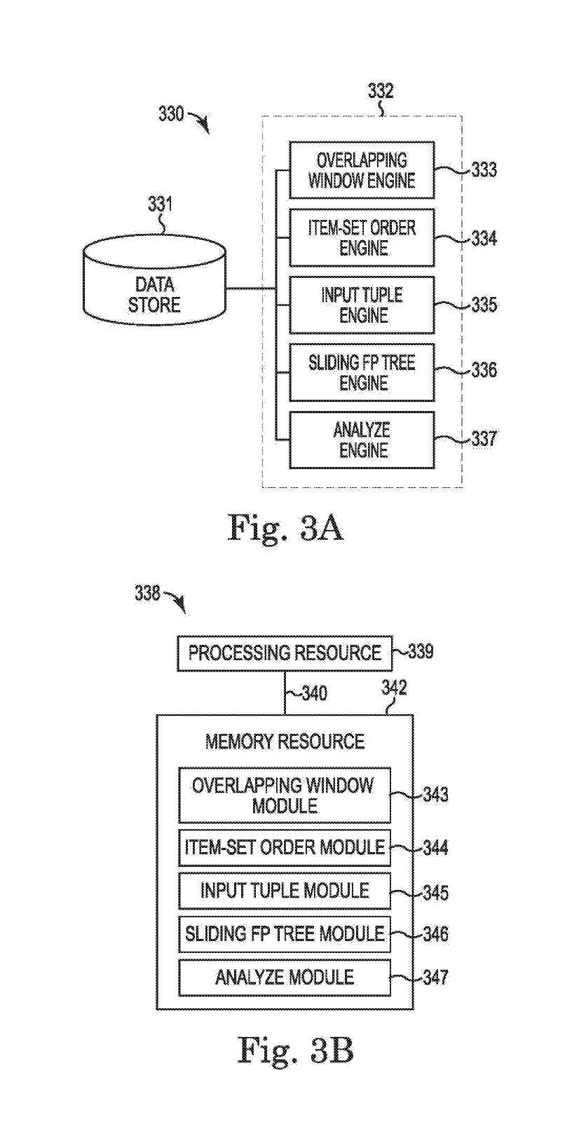

FIGS. 3A-3B illustrate examples of systems 330, 338 according to the present disclosure. FIG. 3A illustrates a diagram of an example of a system 330 for analyzing a parallel data stream using a sliding FP tree according to the present disclosure. The system 330 can include a data store 331, analysis system 332, and/or a number of engines 333, 334, 335, 336, 337. The analysis system 332 can be in communication with the data store 331 via a communication link, and can include the number of engines (e.g., overlapping window engine 333, item-set order engine 334, input tuple engine 335, sliding FP tree engine 336, analyze engine 337, etc.) The analysis system 332 can include additional or fewer engines than illustrated to perform the various functions described herein.

The number of engines 333, 334, 335, 336, 337 can include a combination of hardware and programming that is configured to perform a number of functions described herein (e g., identify frequent item-sets in the parallel data stream using a plurality of sliding FP trees). The programing can include program instructions (e.g., software, firmware, etc.) stored in a memory resource (e.g., computer readable medium, machine readable medium, etc.) as well as hard-wired program (e.g., logic).

The overlapping window engine 333 can include hardware and/or a combination of hardware and programming to define a plurality of parallel sliding window boundaries. Defining a plurality of parallel sliding windows can include defining a boundary for each of the plurality of parallel sliding windows for a number of sliding FP tree task instances. The parallel sliding windows can, for instance, overlap over one or more slides.

The item-set order engine 334 can include hardware and/or a combination of hardware and programming to organize input tuples using a defined frequency based order of a plurality of item-sets. The defined frequency based order can include for instance, a sequence of pre-ordered items (e.g., Itemsequence). For example, input tuples with fields “granule”, “tid”, “prefix”, and “itemlist” are received and sorted based on the order and field partitioned by the field “prefix.”

The sequence of pre-ordered items can, for instance, be based on an estimated frequency of items of the given application domain. The estimated frequency can be based on past experience and/or training. In various examples, the defined frequency based order can be changed when the parallel data stream is re-analyzed. That is, the order can include a parameter that can be revised.

The input tuple engine 335 can include hardware and/or a combination of hardware and programming to store input tuples belonging to a second parallel sliding window boundary (e.g., belonging to the next parallel sliding window and/or a future parallel sliding window). An input tuple belonging to a second parallel sliding window boundary can include a tuple from a future parallel sliding window (e.g., that occurs within the boundary of the future parallel sliding window). The input tuples can be determined to belong to a future parallel sliding window boundary based on a granule of the input tuple being greater than a boundary of the current parallel sliding window.

For instance, a number of data structures can be defined. The number of data structures can be defined by a separate engine (e.g., data structure engine) and/or can be a sub-part of the item-set order engine 334 and/or input tuple engine 335. The number of data structures can include a sliding FP tree data structure (e.g., SlidingFPTree, sfpTree) to hold the patterns, a pattern count map (e.g., a hash map and/or other index data structure) that keeps pattern-frequency pairs for each parallel sliding window, an index table (e.g., an ArrayList<Index> indexTable) that keeps the tree nodes for each item, an item sequence list data structure (e.g., ArrayList<String> Itemsequence) as discussed above, a pool transaction list data structure (LinkedList<PooledTX> pooledTX) that buffers the input transactions for shifting the sliding FP tree over parallel sliding windows.

Further, the data structures can include a granule table (e.g., Hashtable<Integer, Long> granuleTable) that keeps the granule number of each input channel. The analysis system 332 enters a new parallel sliding window boundary only when the input tuples from all the input channels (e.g., for a sliding FP tree task instance) reach the current parallel sliding window boundary (e,g., fall in the new parallel sliding window boundary). Before this point, any input tuple with a granule number more advanced than the current parallel sliding window boundary (e.g., for a sliding FP tree task instance) is stored to be processed in a future parallel sliding window (e.g., that the input tuple belongs to). Storing an input tuple, as used herein, can include temporarily storing the input tuple (e.g., holding). And, the data structures can include a held tuple data structure (e.g., ArrayList<Tuple>held_tuples) for storing the tuples belonging to a future parallel sliding window. These held tuples are process later when the analysis system 332 enters the parallel sliding window that tuples belong to.

In various instances, a task can keep a number of variables for dealing with the parallel sliding window semantic. For instance, the variables can include window_size that is the number of granules per window, delta that is the number of granules per slide, current that is the current granule number, ceiling that is the ceiling (e.g., granule boundary of the slide) of the current slide by granule number (e.g., once the window_size is reach, it is the ceiling of the current parallel sliding window), and window that is the number (e.g., identifier) of the current parallel sliding window.

In a number of examples, the current granule number (e.g., granule of current processing) is determined by the following process. The input tuples from each individual input channel are delivered in order by granule number, however, the granule numbers of the tuples from multiple input channels in parallel processing may not be synchronized. The granule number of each input channel (e.g., the highest granule number received from an input channel) is maintained in the granule table (e.g., by the input tuple engine 335 and/or a separate data structure engine). Upon receiving a new input tuple, the granule table is updated and the current granule number is resolved as the minimum granule number of ail input channels. If the granule number of the current input tuple is larger than the current granule number, this tuple is held without processing (e.g., it will be process later). Once a parallel sliding window boundary is reached and the analysis system 332 enters the next parallel sliding window, held tuples that belong to (e.g., occur within) the next paralleling sliding window boundary are processed and held tuples that belong to future parallel sliding window boundaries are continued to be held.

The sliding FP tree engine 336 can include hardware and/or a combination of hardware and programming to incrementally create a sliding FP tree for each of a plurality of sliding FP tree task instances using the defined frequency based order. For example, a sliding FP tree for each of the plurality of sliding FP tree task instances can be created using input tuples (e.g., from the identified input channels) belonging to a current parallel sliding window boundary. An increment to one of the sliding FP trees can include adding item-sets to the sliding FP tree identified in a current parallel sliding window boundary among the plurality of parallel sliding window boundaries and subtracting item-sets from the sliding FP tree identified in a previous parallel sliding window boundary among the plurality of parallel sliding window boundaries (e.g., subtract item-sets identified in both the previous parallel sliding window boundary and the current parallel sliding window boundary). The subtracted item-sets can include item-sets from a slide with the lowest granule ceiling among the item-sets. For example, for each input tuple, the sliding FP tree engine 336 can process the input tuple based on:

```
current = resolveGranule (tuple);
if (current >= ceiling) {
      if (current > window_size) {
            summarize_window( );
            window++;
      }
      ceiling = (current/delta +1) *delta;
      process_held_tuples(ceiling);
}
if (getGranule (tuple) >=ceiling) {
} else {
      process_tuple(tuple);
}.
```

The procedure can process input tuples in a per-tuple process to update the sliding FP tree (e.g., sliding FP tree data structure).

For instance, process_tuple(tuple) can include resolving the current granule over all input channels, if the input tuple belongs to the current slide and/or current parallel sliding window, it is processed. If not, the input tuple is held (e.g., stored) to be processed in a future parallel sliding window that it belongs to. Processing the input tuple can include pre-processing the transaction into an ordered item-list using the defined frequency based order of a plurality of item-sets and the prefix item (e.g., by the item-set order engine 334). A number of data structure can be updated including the sliding FP tree data structure, onpTree (e.g., partial sliding FP tree data structure), and the indexLink (e.g., index table). Further, the item-list can be added to the pooled transaction list data structure (e.g., pooledTx).

The summarize_window( ) can include extracting (e.g., mining) patterns on the sliding FP tree with index table, the results are entered to a pattern count map. Patterns and counters for the current parallel sliding window can be emitted based on the resulting pattern count map. The pattern count map, in various examples, can be cleared to be used in the next parallel sliding window. Further, input transaction list of transactions failing in the earliest pooled slide can be retrieved from the pooled transaction list data structure (e.g., pooledTX), and these transactions can be subtracted from the sliding FP tree in reverse order (e.g., subtract counters in the nodes). The pooled transaction list data structure can be slid (e.g., shifted) by dropping the input transaction list of transactions belonging to the earliest pooled slide. That is the pattern count map of each sliding FP tree can include a subtraction of counts of nodes belonging to a transaction in the previous parallel sliding window in a reverse order.

The analyze engine 337 can include hardware and/or a combination of hardware and programming to identify frequent item-sets in the parallel data stream using the plurality of sliding FP trees. Identifying and/or analyzing frequent item-sets can include extracting frequent item-sets for each of the plurality of sliding FP tree, for instance. The analyze engine 337 can be used to summarize results at each parallel sliding window across all input channels of a plurality of sliding FP tree task instances. For instance, summarizing can include combining the pattern count maps from the plurality of sliding FP tree task instances. That is, the analyze engine 337 can summarize results at each parallel sliding window, wherein each summary of a parallel sliding window includes a combination of pattern count maps from each of the plurality of sliding FP tree task instances.

FIG. 3B illustrates a diagram of an example computing device 338 according to the present disclosure. The computing device 338 can utilize software, hardware, firmware, and/or logic to perform a number of functions described herein.

The computing device 338 can be any combination of hardware and program instructions configured to share information. The hardware, for example can include a processing resource 339 and/or a memory resource 342 (e g., computer-readable medium (CRM), machine readable medium (MRM), database, etc.) A processing resource 339, as used herein, can include any number of processors capable of executing instructions stored by a memory resource 342. Processing resource 339 may be integrated in a single device or distributed across multiple devices. The program instructions (e.g., computer-readable instructions (CRI)) can include instructions stored on the memory resource 342 and executable by the processing resource 339 to implement a desired function (e.g., analyze patterns of the parallel data stream).

The memory resource 342 can be in communication with a processing resource 339. A memory resource 342, as used herein, can include any number of memory components capable of storing instructions that can be executed by processing resource 339. Such memory resource 342 can be a non-transitory CRM or MRM. Memory resource 342 may be integrated in a single device or distributed across multiple devices. Further, memory resource 342 may be fully or partially integrated in the same device as processing resource 339 or it may be separate but accessible to that device and processing resource 339. Thus, it is noted that the computing device 338 may be implemented on a participant device, on a server device, on a collection of server devices, and/or a combination of the user device and the server device.

The memory resource 342 can be in communication with the processing resource 339 via a communication link (e.g., a path) 340. The communication link 340 can be local or remote to a machine (e.g., a computing device) associated with the processing resource 339. Examples of a local communication link 340 can include an electronic bus internal to a machine (e.g., a computing device) where the memory resource 342 is one of volatile, non-volatile, fixed, and/or removable storage medium in communication with the processing resource 339 via the electronic bus.

A number of modules 343, 344, 345, 346, 347 can include CRI that when executed by the processing resource 339 can perform a number of functions. The number of modules 343, 344, 345, 346, 347 can be sub-modules of other modules. For example, the input tuple module 345 and the sliding FP tree module 346 can be sub-modules and/or contained within the same computing device. In another example, the number of modules 343, 344, 345, 346, 347 can comprise individual modules at separate and distinct locations (e.g., CRM, etc.).

Each of the number of modules 343, 344, 345, 346, 347 can include instructions that when executed by the processing resource 339 can function as a corresponding engine as described herein. For example, the overlapping window module 343 can include instructions that when executed by the processing resource 339 can function as the overlapping window engine 333. In another example, the item-set order module 344 can include instructions that when executed by the processing resource 339 can function as the item-set order engine 334.

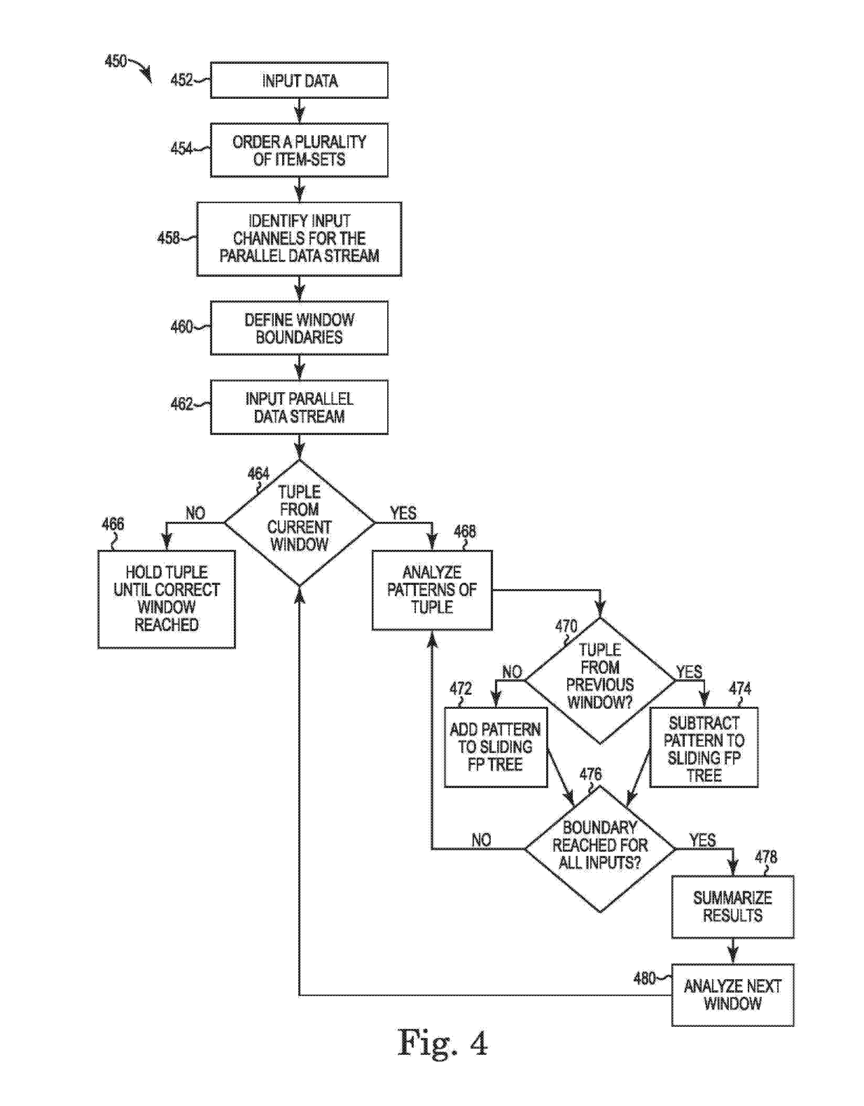

FIG. 4 is a flow chart illustrating a process 460 for analyzing a parallel data stream using a sliding FP tree according to the present disclosure. At 452, data can be input. The input data can include identification of items associated with the data stream, a dataflow process topology, an identification of frequency of items (e.g., based on historical data, training, and/or past experience), among other data.

At 454, the plurality of items and/or item-sets can be ordered based on a frequency of each item and/or item-set. For instance, the order can be a defined frequency based order of the plurality of item-sets that can be determined using historical data, training, and/or past experience.

At 458, input channels for the parallel data stream can be identified. For instance, the input channels can be defined using a dataflow process topology. A dataflow process topology, as used herein, can include a data structure describing paths that data can take between nodes in a streaming system. The input channels identified can, for example, be input channels for a sliding FP tree task. In a number of examples, the sliding FP tree task can be parallelized (e.g., a plurality of sliding FP tree task instances can exist) and input channels for each of a plurality of sliding FP tree task instances can be identified.

At 460, window boundaries can be defined. Window boundaries can be based on a pre-defined granule size of each parallel sliding window. In various examples, a variety of other variables and/or data structures can be defined. Example variables and/or data structures can include slide size (e.g., delta), the sliding FP tree data structure, pattern count map, index table, pooled transaction list, granule table, held tuples data structure, among other variables and/or data structures.

At 462, the parallel data stream can be input. Inputting the parallel data stream can, for example, include sending tuples to a sliding FP tree task and/or a sliding FP tree task instance to analyze the tuples for frequent patterns.

At 464, it can be determined if an input tuple belongs to the current parallel sliding window. In response to the input tuple belonging to a future parallel sliding window, at 466, the tuple can be held (e.g., stored in the held tuple data structure) until the correct parallel sliding window is reached (e.g., processed). In response to the input tuple belonging to the current parallel sliding window, at 468, the input tuple can be analyzed for patterns. For instance, a path of a transaction can be added to the sliding FP tree.

At 470, it can be determine if the input tuple (e.g., the transaction) belongs to a previous parallel sliding window. Tuples belonging to a previous parallel sliding window, as used herein, can include tuples in the earliest slide (e.g., the slide with a lowest granule ceiling) from the pooled transaction list. At 472, input tuples not belonging to the previous parallel sliding window (e.g., not belonging to the earliest slide) can have their corresponding pattern added to the sliding FP tree.

At 474, input tuples belonging to the previous parallel sliding window can have their corresponding patterns subtracted from the sliding FP tree. That is, transactions listed as falling in the earliest slide can be subtracted from the sliding FP tree in a reverse order. Subtracting transactions, as used herein, can include subtracting counters of corresponding nodes.

At 476, it can be determined if the current parallel sliding window boundary is reached by all input channels (e.g., for a sliding FP tree task instance). That is, the granule number of each input channel has reached the ceiling of the current parallel sliding window. If the boundary has not been reached, the analyses of input tuples can be repeated (e.g., analyze patterns of tuple 468, tuple from previous parallel sliding window 470, etc.)

If the boundary has been reached, at 478, the results of the plurality of sliding FP trees can be summarized. For instance, frequent item-sets from each of the plurality of sliding FP trees can be summarized. In a number of examples, the summary can include a combination of pattern count maps of a plurality of sliding FP tree task instances.

At 480, the next parallel sliding window can be analyzed. Analyzing the next parallel sliding window can include repeating a variety of steps to analyze patterns of input tuples belonging to the next parallel sliding window including processing input tuples held from past parallel sliding windows.

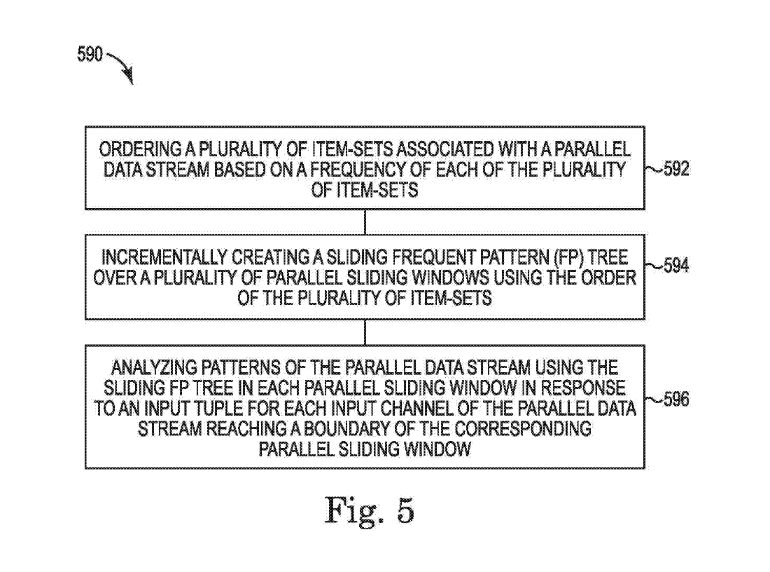

FIG. 5 is a flow chart illustrating an example of a method 598 for analyzing a parallel data stream using a sliding FP tree according to the present disclosure. At 592, the method 590 can include ordering a plurality of item-sets associated with a parallel data stream based on a frequency of each of the plurality of item-sets. The frequency can include an estimate based on historical data, past experience, and/or training, for instance.

At 594, the method 590 can include incrementally creating a sliding FP tree over a plurality of parallel sliding windows using the order of the plurality of item-sets. For instance, incrementally creating can include incrementally building and pruning the sliding FP tree along the plurality of parallel sliding windows. Creating the sliding FP tree can include adding patterns to the sliding FP tree identified from a current parallel sliding window and subtracting patterns from the sliding FP tree identified from a previous parallel sliding window. For instance, the parallel sliding windows can overlap across common slides. Patterns identified in the current parallel sliding window can be added to the sliding FP tree and patterns identified from an earliest slide (e.g., slide with the lowest granule ceiling of the previous parallel sliding window) can be subtracted.

In some examples, tuples from input channels may not be received in order. In such an instance, input tuples belonging to a different parallel sliding window (e.g., a future parallel sliding window) than a current parallel sliding window can be held for future processing.

At 596, the method 590 can include analyzing patterns of the parallel data stream using the sliding FP tree in each parallel sliding window in response to an input tuple for each input channel of the parallel data stream reaching a boundary of the corresponding parallel sliding window. That is, a sliding FP tree for each parallel sliding window (e.g., a current parallel sliding window) among the plurality of parallel sliding windows can be analyzed in response to an input tuple for each input channel reaching a boundary of the corresponding parallel sliding window. A corresponding parallel sliding window, as used herein, can include a current parallel sliding window.

In various examples, the sliding FP tree can be for a sliding FP tree task instance among a plurality of sliding FP tree task instances. The analyzed patterns, in such examples, can include combined identified frequent item-sets from a plurality of sliding FP trees (e.g., combine window results from a plurality of sliding FP tree task instances once each of the sliding FP tree task instances reaching the window boundary).

For example, analyzing patterns can include summarizing the patterns from a plurality of sliding FP trees, wherein each of the plurality of sliding FP trees is associated with a sliding FP tree task instance among a plurality of sliding FP tree task instances of the parallel data stream. The patterns from each sliding FP tree can be placed in a pattern count map. In various examples, the pattern count maps of each sliding FP tree can be combined.

In the detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be used and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators “P” and “Q” particularly with respect to reference numerals in the drawings, indicate that a number of the particular feature so designated can be included with a number of examples of the present disclosure.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A non-transitory computer-readable medium storing instructions executable by a processing resource to cause a computer to:
identify input channels for a plurality of sliding frequent pattern (FP) tree task instances of a parallel data stream;
create a sliding FP tree for each of the plurality of sliding FP tree task instances using input tuples from the identified input channels belonging to a first parallel sliding window boundary; and
analyze patterns of the parallel data stream first parallel sliding window boundary using the plurality of sliding FP trees.

2. The non-transitory computer-readable medium of claim 1, wherein the instructions executable by the processing resource to analyze patterns of the parallel data stream include instructions executable to:
combine patterns of each of the plurality of sliding FP trees in response to an input tuple from each input channel reaching a granule boundary of the first parallel sliding window.

3. The non-transitory computer-readable medium of claim 1, wherein the instructions executable by the processing resource include instructions executable to hold an input tuple from the first parallel sliding window based on the input tuple belonging to a second parallel sliding window boundary.

4. The non-transitory computer readable medium of claim 1, wherein the instructions executable by the processing resource to analyze patterns of the parallel data stream include instructions executable to extract frequent item-sets from each of the plurality of sliding FP trees.

5. The non-transitory computer-readable medium of claim 4, wherein the instructions executable by the processing resource include instructions executable to disregard item-sets with a frequency below a threshold frequency.

6. The non-transitory computer-readable medium of claim 1, wherein the instructions executable by the processing resource include instructions executable to update a current granule number as a minimum granule number of each input channel.

7. A method for analyzing a parallel data stream, including:
ordering a plurality of item-sets associated with a parallel data stream based on a frequency of each of the plurality of item-sets;
incrementally creating a sliding frequent pattern (FP) tree over a plurality of parallel sliding windows using the order of the plurality of item-sets; and
analyzing patterns of the parallel data stream using the sliding FP tree in each parallel sliding window in response to an input tuple for each input channel of the parallel data stream reaching a boundary of the corresponding parallel sliding window.

8. The method of claim 7, wherein creating the sliding FP tree includes incrementally building and pruning the sliding FP tree along the plurality of parallel sliding windows.

9. The method of claim 7, wherein creating the sliding FP tree includes:
adding patterns to the sliding FP tree identified in a current parallel sliding window; and
subtracting patterns from the sliding FP tree identified in a slide in a previous parallel sliding window.

10. The method of claim 7, wherein analyzing patterns of the parallel data stream includes:
summarizing the patterns from a plurality of sliding FP trees, wherein each of the plurality of sliding FP trees is associated with a sliding FP tree task instance among a plurality of sliding FP tree task instances of the parallel data stream; and
placing the pattern of each sliding FP tree in a pattern count map.

11. The method of claim 7, wherein incrementally creating the sliding FP tree includes holding an input tuple belonging to a different parallel sliding window than a current parallel sliding window.

12. A system for analyzing a parallel data stream, comprising:
a processing resource; and
a memory resource communicatively coupled to the processing resource containing instructions executable by the processing resource to implement a number of engines including:
a parallel window engine to define a plurality of parallel sliding window boundaries;
an item-set order engine to organize input tuples using a defined frequency baser order of a plurality of item-sets;
an input tuple engine to store input tuples belonging to a future parallel sliding window;
a sliding FP tree engine to incrementally create a sliding FP tree for each of a plurality of sliding FP tree task instances using the defined frequency based order, wherein each increment to one of the sliding FP trees includes:
add item-sets to the sliding FP tree identified in a current parallel sliding window boundary among the plurality of parallel sliding window boundaries; and
subtract item-sets from the sliding FP tree identified in a previous parallel sliding window boundary among the plurality of sliding window boundaries; and
an analyze engine to identify frequent item-sets in the parallel data stream using the plurality of sliding FP trees.

13. The system of claim 12, wherein an item-set is identified as frequent in response to an identified frequency in the current parallel sliding window boundary being greater than a threshold frequency.

14. The system of claim 12, wherein the analyze engine further summarizes results at each parallel sliding window, wherein a summarized result at one of the parallel sliding windows includes a combined pattern count map from each of the plurality of sliding FP tree task instances.

15. The system of claim 12, wherein the subtracted item-sets from the sliding FP tree includes a subtraction of counts of nodes belonging to a transaction in the previous parallel sliding window in a reverse order.
